(19) United States
(12) Patent Application Publication
(10) Pub. No.: US 2018/0122152 A1
(43) Pub. Date: May 3, 2018

(54) PARKING LOT MANAGEMENT METHOD, PARKING LOT MANAGEMENT SERVER, AND PARKING LOT MANAGEMENT SYSTEM

(71) Applicant: PARKINGCLOUD CO., LTD., Seoul (KR)

(72) Inventor: Sang Yong SHIN, Seoul (KR)

(21) Appl. No.: 15/560,863

(22) PCT Filed: Dec. 16, 2015
(86) PCT No.: PCT/KR2015/013784

§ 371 Date: Sep. 22, 2017

(30) Foreign Application Priority Data
Mar. 31, 2015 (KR) 10-2015-0044876

(51) Int. Cl. G07B 15/02; G08G 1/017; G08G 1/14; G06Q 20/24; G06Q 20/28; G06Q 20/40

(52) U.S. Cl. CPC G07B 15/02; G08G 1/0175; G06Q 20/4014; G06Q 20/24; G06Q 20/28; G08G 1/144

(57) ABSTRACT

A parking lot management method, a parking lot management server, and a parking lot management system where the method includes the steps of: (a) receiving vehicle entry information including a vehicle license plate number; b) generating a vehicle entry guide message of a vehicle associated with the vehicle license plate number; and (c) transmitting the vehicle entry guide message to a user's mobile phone associated with the vehicle license plate number by using the vehicle entry information including the vehicle license plate number, wherein the vehicle entry guide message includes information on a parking lot where the vehicle associated with the vehicle license plate number enters, and guide information on a partnership store associated with the parking lot, the vehicle entry guide message being displayed on the user's mobile phone.

### BACKGROUND

The present invention relates to a parking lot management method, a parking lot management server, and parking lot management system. More particularly, the present invention relates to a parking lot management method, a parking lot management server, and parking lot management system, in which the local parking management terminal and parking lot management server interwork with each other, so that when a vehicle enters and exits a parking lot, parking fee settlement and discount processing are achieved automatically, and parking lot users are informed automatically of services provided by neighborhood commercial areas.

In general, a driver can visit various places by using his/her vehicle. When a driver visits a place, he/she needs to park his/her vehicle. For example, a vehicle user enters a parking lot to park his/her vehicle, and according to vehicle entry, receives an entry (parking) ticket (receipt) indicating an entry time, a vehicle license plate number, etc. from a parking lot manager.

When the vehicle user returns to the parking lot after finishing his/her business he/she drives to the exit gate of the parking lot to pay the parking fee.

In order to provide smooth entry and exit of vehicles, there is a parking lot that adopts a License Plate Recognition (LPR) system. The LPR system automatically recognizes the vehicle license plate number through a camera at the entrance gate and also recognizes the vehicle license plate number through the camera at the exit gate.

The LPR system is configured such that the parking fee of a corresponding vehicle can be determined using the automatically recognized vehicle license plate number at the entrance and exit gates, and the parking fee can be paid to a parking lot manager at the exit gate.

As described above, in the case of the LPR parking system that has been applied in recent years, it is possible only to automatically recognize the vehicle license plate number of the vehicle entering or exiting the parking lot. Accordingly, the conventional known parking management system has various inconveniences.

First, the conventional parking management system requires the intervention of the parking lot manager or the vehicle user in order to settle the parking fee. In other words, in the conventional parking management system, the parking lot manager informs the vehicle user of the parking fee by recognizing the vehicle license plate number through LPR whereby the fee from the vehicle user can be collected. Alternatively, in the conventional parking management system, the vehicle user may present the parking ticket received at the time of parking to the automated payment machine and settle the fee using a credit card or the like.

When the settlement process of the parking fee in the conventional parking management system is automated, it is possible to provide a more convenient parking management (use) environment for the parking lot manager and the vehicle user.

It is also necessary to reflect the characteristics of the parking lot use in the automatic settlement of the parking fee. For example, a parking lot is generally associated with various neighborhood stores. Accordingly, it is necessary to allow a vehicle user that enters a certain parking lot to be automatically informed of a store that supports use of the certain parking lot, or to allow the parking fee to be automatically discounted according to the use of the corresponding store patronized by the vehicle user. When the parking fee is automatically discounted, this can be utilized to promote a certain neighborhood store of the various associated neighborhood stores.

In addition, if the vehicle user can know the location, the current situation, etc. of the parking lots in a certain area and thus can reserve entry to a certain parking lot, the vehicle user does not need to search for a parking lot having available parking spaces, and it is possible for the parking lot to stably secure customers.

Thus, there is a demand for a parking lot management method, a parking lot management server, and a parking lot management system, in which the above problems can be solved.

### SUMMARY OF THE INVENTION

Accordingly, the present invention has been made keeping in mind the above problems occurring in the prior art, and an object of the present invention is to provide a parking lot management method, a parking lot management server, and a parking lot management system, in which the settlement process of the parking fee is automated, thereby providing a more convenient parking management (use) environment for the parking lot manager and the vehicle user.

Another object of the present invention is to provide a parking lot management method, a parking lot management server, and a parking lot management system, in which upon vehicle entry, various information on the vehicle entry and partnership store information is provided to the vehicle user's mobile phone, so that the vehicle user can automatically recognize entry into the parking lot and know a certain store that supports use of or is associated with the corresponding parking lot.

A further object of the present invention is to provide a parking lot management method, a parking lot management server, and a parking lot management system, in which upon vehicle exit, the parking fee is automatically discounted in connection with a certain store used by the vehicle user, and the vehicle user can conveniently search for and reserve entry to a parking lot.

However, the technical problem which is intended to be solved by the present invention is not limited to the above aspects, and other technical problems will be able to be apparently understood by those skilled in the art from the following description.

In order to accomplish the above object, the present invention provides a parking lot management method including the steps of: (a) receiving vehicle entry information including a vehicle license plate number; b) generating a vehicle entry guide message of a vehicle associated with the vehicle license plate number; and (c) transmitting the vehicle entry guide message to a user's mobile phone associated with the vehicle license plate number by using the vehicle entry information including the vehicle license plate number, wherein the vehicle entry guide message includes information on a parking lot where the vehicle associated with the vehicle license plate number enters, and guide information on a partnership store associated with the parking lot, the vehicle entry guide message being displayed on the user's mobile phone.

In order to accomplish the above object, the present invention provides a parking lot management server including: a communication unit receiving vehicle entry information including a vehicle license plate number and transmitting a vehicle entry guide message to a user's mobile phone associated with the vehicle license plate number; and a control unit generating a vehicle entry guide message for a vehicle associated with the vehicle license plate number, and forwarding the vehicle entry guide message to the communication unit to transmit the generated vehicle entry guide message to the user's mobile phone associated with the vehicle license plate number, wherein the vehicle entry guide message includes information on a parking lot where the vehicle associated with the vehicle license plate number enters, and guide information on a partnership store associated with the parking lot, the vehicle entry guide message being displayed on the user's mobile phone.

In order to accomplish the above object, the present invention provides a parking lot management system including the parking lot management server, wherein the parking lot management server includes: a communication unit receiving vehicle entry information including a vehicle license plate number and transmitting a vehicle entry guide message to a user's mobile phone associated with the vehicle license plate number; and a control unit generating a vehicle entry guide message for a vehicle associated with the vehicle license plate number, and forwarding the vehicle entry guide message to the communication unit to transmit the generated vehicle entry guide message to the user's mobile phone associated with the vehicle license plate number, wherein the vehicle entry guide message includes information on a parking lot where the vehicle associated with the vehicle license plate number enters, and guide information on a partnership store associated with the parking lot, the vehicle entry guide message being displayed on the mobile phone.

As described above, in the parking lot management method, the parking lot management server, and the parking lot management system according to the present invention, the settlement process of the parking fee can be automated, so that it is possible to provide a more convenient parking management (use) environment for the parking lot manager and the vehicle user.

In addition, in the parking lot management method, the parking lot management server, and the parking lot management system according to the present invention, upon vehicle entry, various information on the vehicle entry and partnership store information is provided to the vehicle user's mobile phone, so that the vehicle user can automatically recognize entry into the parking lot and know a certain store that supports use of or is associated with the corresponding parking lot.

Further, in the parking lot management method, the parking lot management server, and the parking lot management system according to the present invention, upon vehicle exit, the parking fee can be automatically discounted in connection with a certain store patronized by the vehicle user, and the vehicle user can conveniently search for and reserve entry to a parking lot.

It will be appreciated by those skilled in the art that that the effects that can be achieved through the present invention are not limited to what has been particularly described hereinabove and other advantages of the present invention will be more clearly understood from the following detailed description.

### BRIEF DESCRIPTION OF DRAWINGS

FIG. 1 is a view showing an exemplary system block diagram of a parking lot management system.

FIG. 2 is a view showing an exemplary block diagram of a parking lot management server.

FIG. 3 is a view showing an exemplary member registration and pre-purchasable parking product purchase flow for use of the parking lot management system.

FIG. 4 is a view showing an exemplary flow in the parking lot management system for processing vehicle entry into the parking lot and a parking discount.

FIG. 5 is a view showing an exemplary flow in the parking lot management system when a vehicle exits the parking lot.

### DETAILED DESCRIPTION OF THE INVENTION

The above and other objects, features and advantages of the present invention will be more clearly understood from the following detailed description taken in conjunction with the accompanying drawings. Accordingly, the present invention can be easily embodied by those skilled in the art to which this invention belongs. In the following description of the present invention, detailed descriptions of known functions and components incorporated herein will be omitted when it may make the subject matter of the present invention unclear. Hereinbelow, exemplary embodiments of the present invention will be described in detail with reference to the accompanying drawings.

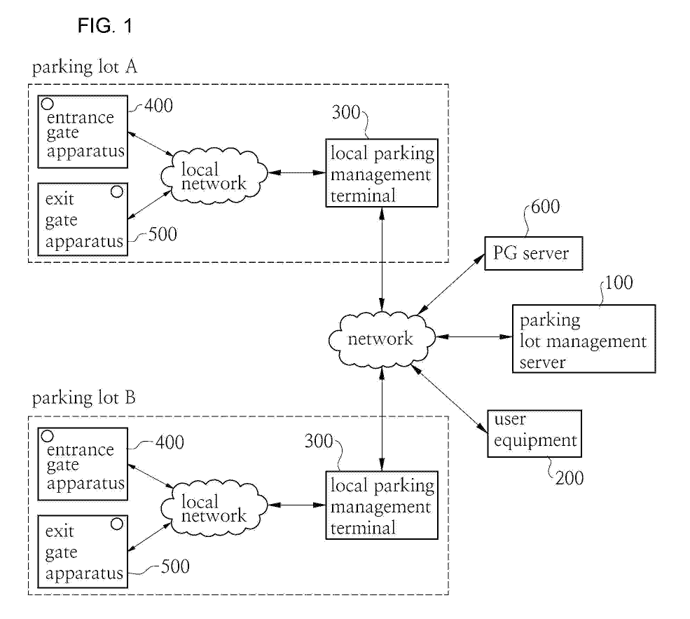

FIG. 1 is a view showing an exemplary system block diagram of a parking lot management system.

Referring to FIG. 1, the present parking lot management system includes a parking lot management server 100, at least one user equipment 200, at least one local parking management terminal 300, at least one entrance gate apparatus 400, at least one exit gate apparatus 500, and a PG server 600. The present parking lot management system may further include other blocks.

Each block of the parking lot management system will be described with reference to FIG. 1. The parking lot management server 100 is a server for managing parking lots registered in the present system. The parking lot management server 100 may be connected to a plurality of local parking management terminals 300 or a plurality of user equipment 200, and is configured to process requests from the local parking management terminal 300 or the user equipment 200 and forward the processing result. The parking lot management server 100 functions as, for example, a HyperText Transfer Protocol (HTTP) server to provide various web pages to the local parking management terminal 300 or the user equipment 200 and to receive data through the web pages.

In particular, the parking lot management server 100 enables automatic parking fee payment and automatic parking fee settlement through data communication with the user equipment 200. It is possible to provide convenience to a user and to a manager of the parking lot as well as providing automatic processing. For example, the user does not need a separate billing process, the manager does not have to be present at the parking lot all the time, and the user can receive automatic discount on the parking fee through a visit to the neighboring stores associated with the parking lot and through authentication.

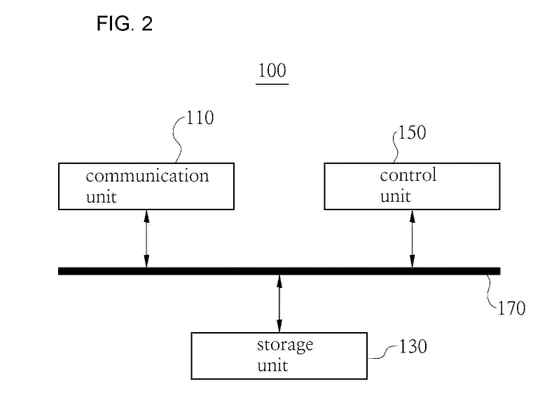

The parking lot management server 100 will be described in detail with reference to FIG. 2.

The user equipment 200 is a device that can be used by a user. The user equipment 200 may be a portable or stationary device. The user equipment 200 may be, for example, a mobile phone or a personal PC. The mobile phone may be a smartphone or a tablet PC or the like. The user equipment 200 can access the parking lot management server 100 through the Internet and can receive and transmit various messages related to vehicle entry and exit into and from the parking lot, and payment from/to the parking lot management server 100 through a network.

The user equipment 200 is generally a device possessed by a vehicle user, and is preferably a mobile phone. The mobile phone is provided with various interfaces and is provided with a wireless interface such as Bluetooth, GPS, NFC, etc., so that the mobile phone can wirelessly communicate with the adjacent device or equipment. The mobile phone can be accessed using a mobile phone number assigned by a mobile carrier through a mobile communication network or an internet network. The mobile phone possessed by the vehicle user receives a message indicating a vehicle entry guide or vehicle exit guide from the parking lot management server 100 that manages a parking lot where the vehicle enters, and displays the received message on a display module (e.g., LCD, LED module) of the mobile phone.

Hereinafter, it is assumed that the user equipment 200 is a mobile phone unless otherwise specified.

The parking lot of the present parking lot management system is composed of a plurality of devices. The parking lot includes at least one entrance gate apparatus 400, at least one exit gate apparatus 500, and a local parking management terminal 300.

The entrance gate apparatus 430 of the parking lot is a device that is installed at the entrance gate of the parking lot. The entrance gate apparatus 430 includes at least a camera module and a control module. The camera module captures an image of an entering vehicle and the control module extracts a vehicle license plate number from the captured vehicle image. The vehicle license plate number can be extracted using an optical character reader (OCR) program.

The entrance gate apparatus 400 further includes a blocking bar, a beacon module, an NFC module, and/or an RF module. The control module of the entrance gate apparatus 400 can use another auxiliary module when it is impossible to extract (recognize) the vehicle license plate number through the OCR. For example, the control module can recognize an identifier for the vehicle user through a beacon module that periodically transmits a beacon signal or the like and receives a Bluetooth signal from a mobile phone or the like. Alternatively, the control module can recognize the identifier for the vehicle user through communication with a mobile phone via the NFC module or the RF module. The identifier may be, for example, a user identifier such as a member ID, or a mobile phone identifier such as a mobile phone number. Thus, the control module can recognize the user identifier through wireless communication provided by the beacon module, the NFC module, and the like.

The entrance gate apparatus 400 can automatically determine the vehicle license plate number or further include a communication module to receive the vehicle license plate number by transmitting the recognized identifier to the local parking management terminal 300 connected thereto through a local network. The entrance gate apparatus 400 can transmit data such as the extracted or recognized vehicle license plate number, the captured vehicle image, an entry time, etc. to the local parking management terminal 300 through the local network.

The identifier identified from the NFC module, the RF module, and the beacon module can be used even when the vehicle license plate number is recognized, and for example, the corresponding identifier can be transmitted to the local parking management terminal 300 together with the vehicle license plate number.

When the vehicle license plate number is not recognized, a GPS module of the mobile phone may be utilized. For example, the user may utilize the GPS module of his or her mobile phone to provide a location of the mobile phone and the identifier (identifier of the user or mobile phone) to the parking lot management server 100, and the parking lot management server 100 may provide the local parking management terminal 300 of a certain parking lot with the vehicle license plate number of the entering vehicle from the location of the mobile phone.

Thus, the entrance gate apparatus 400 transmits the vehicle license plate number, the vehicle image, and the entry time to the local parking management terminal 300 connected thereto through the local network, raises the blocking bar to open the entrance gate, and allows entry of the recognized vehicle.

The local parking management terminal 300 of the parking lot is connected to the entrance gate apparatus 400 and to the exit gate apparatus 500 through the local network, and is connected to the parking lot management server 100 through the Internet or the like.

The local parking management terminal 300 stores various data related to vehicle entry and exit into and from the parking lot, and calculates the parking fee according to the vehicle exit. The local parking management terminal 300 can identify a member who has pre-purchased a parking ticket (parking product) by interworking with the parking lot management server 100. For example, the local parking management terminal 300 can provide the parking lot management server 100 with the parking product (for example, the daily ticket, weekly ticket, monthly ticket, etc.) provided by the corresponding parking lot, and receive the identifier of the user (member) using the corresponding parking product together with an identifier of the parking product and store them in advance.

In order for the local parking management terminal 300 to perform various functions, the local parking management terminal 300 includes at least a processor, a storage medium, and a communication module. The processor may load a program stored in the storage medium (e.g., a hard disk) to manage the corresponding parking lot. The communication module includes a chipset for connection to the Internet or the local network, and transmits and receives various data to/from the entry and exit gate apparatuses 400 and 500 through the local network, and transmits and receives various data to/from the parking lot management server 100 through the Internet or the like.

The local parking management terminal 300 is connected to the exit gate apparatus 500. The exit gate apparatus 500 includes a camera module, a blocking bar, a control module, and a communication module. The control module of the exit gate apparatus 500 controls the blocking bar according to a gate open control signal received from the communication module through the local network. Thus, the local parking management terminal 300 can open the exit gate connected thereto through the local network. The exit gate apparatus 500 may further include a beacon module and the like.

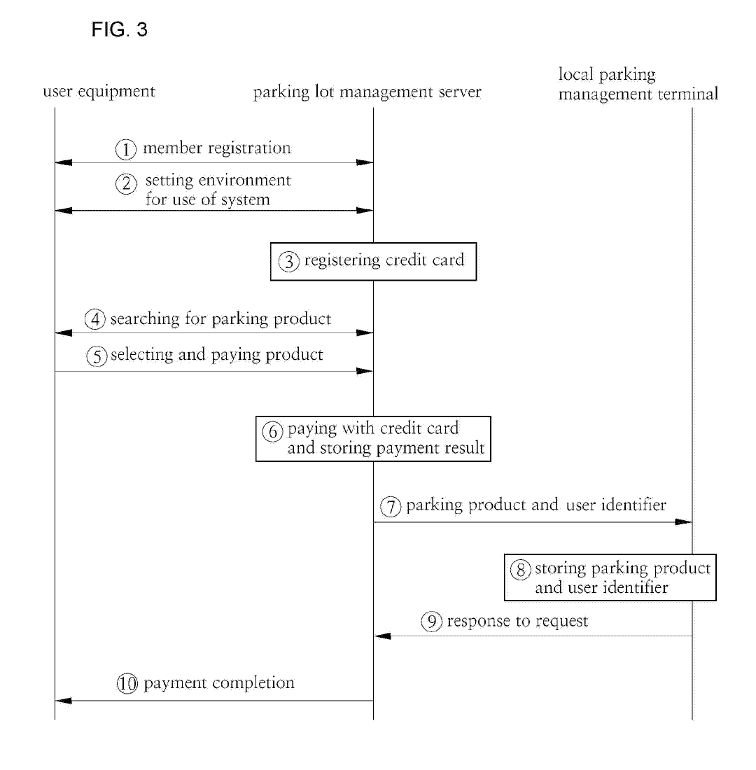

The processing performed in the local parking management terminal 300 by interworking with the parking lot management server 100 will be described in detail with reference to FIGS. 3 to 5.

The PG server 600 is a server that is operated by a payment gateway. The PG server 600 provides various functions related to authentication, approval, and payment of a credit card. Through the PG server 600, it is possible to pre-purchase the parking product, process the parking fee in real time, and process a deferred payment of the parking fee.

The network transmits and receives data. The network is connected to various devices to transmit and receive data packets between the devices. The network may include a local area network and a broadband network. The network includes a mobile communication network and further includes an Internet network. The mobile communication network may be recognized as a part of the Internet network.

FIG. 2 is a view showing an exemplary block diagram of the parking lot management server.

Referring to FIG. 2, the parking lot management server 100 includes a communication unit 110, a storage unit 130, a connection unit 170, and a control unit 150. The block diagram of FIG. 2 preferably represents a functional block diagram, and the parking lot management server 100 is provided with hardware for implementing the functional block diagram.

For example, the parking lot management server 100 includes a LAN card for connection with a wired or wireless LAN, a LAN chipset, at least one hard disk for storing programs and various data, at least one processor for executing the programs, and parallel/serial buses for transmitting and receiving various digital data between the processor, the hard disk, and the LAN card.

Alternatively, the parking lot management server 100 is configured as a combination of at least one computer, a workstation, a data storage server, and the like such that a specific one or a plurality of devices perform functions such as communication, storage, and/or control, etc. Thus, the parking lot management server 100 can have various types of hardware configurations.

Each functional block of the parking lot management server 100 is briefly described. The communication unit 110 is connected to the network, and receives and transmits various data through the network. Specifically, the communication unit 110 receives various data and transmits response data according to processing of various data through the network.

The storage unit 130 stores various data. The storage unit 130 stores various data for use of the present parking lot management system and preferably stores the data in a database form. For example, the storage unit 130 includes at least a user (member, hereinafter ‘user’ and ‘member’ are used in combination) DB and a parking lot DB.

The user DB is a DB for managing users registered as members in the present parking lot management system. The user DB is configured with a plurality of entries, and each entry is assigned to each user. An entry is configured with a plurality of fields and each field is predefined. One entry may be configured in various forms depending on the type of the field or the like.

For example, a user entry includes a user (member) name, the identifier (ID), a password, an e-mail address and the like, and further includes the mobile phone identifier, the vehicle license plate number (further, vehicle model name) and the like. The mobile phone identifier is an identifier used when connecting to the mobile phone or forwarding data through the network, and is, for example, the identifier of the mobile phone used for forwarding a mobile phone number or a push message. The vehicle license plate number is a license number of a vehicle used by the corresponding user.

The user entry may further include a credit card list and cyber money. The credit card list is a list representing at least one credit card and stores information about each credit card. The credit card information includes, for example, a credit card name, a credit card number, an expiration date and the like, and may further include a credit card company name, a card type, a password and the like. The credit card list can be used for credit card payment, can have priority over payment approval, and the corresponding priority may be predetermined by the user. The cyber money is online money that can be used for payment of parking fees in the present parking lot management system. The cyber money can be charged at the time of member (user) registration or can be charged when necessary. The cyber money, for example, can be charged with points of the credit card of the user or can be paid by the credit card. The cyber money can be conveniently used for the deferred payment of the parking fee.

The user entry further includes an available and pre-purchased parking product list. The parking product list is composed of at least one parking product, and each parking product includes a parking lot identifier, a parking product identifier of the parking lot, and may further include duration, a purchase price and the like. The parking product list includes currently available parking products and further includes parking products that have been purchased in the past.

The user entry includes parking lot vehicle entry and exit lists. The parking lot vehicle entry and exit lists store entry and exit information on vehicles that used the registered parking lots, respectively. For example, the parking lot vehicle entry and exit information includes the parking lot identifier, the entry time, the exit time, the parking fee, discount details and the like. The discount details include discount details applied when using corresponding parking lot and discount details applied using a mobile stamp identifier. The user entry further includes an available mobile stamp list. Each mobile stamp in the mobile stamp list stores information such as the mobile stamp identifier, available duration, applied discount details (e.g., one hour discount, 20% discount) and the like.

As can be seen from the user entry, the user (member) can pre-purchase the parking product, or can make the deferred payment using a credit card after entering the parking lot. The user can also pay the parking fee using the points.

The parking lot DB is a DB for managing parking lots registered in the present parking lot management system. The parking lot DB is configured with a plurality of entries. Each parking lot entry corresponds to one parking lot and is configured with a plurality of fields. One entry may be configured in various forms depending on the type of the field and the like.

One parking lot entry corresponds to one parking lot, and includes a parking lot name, the parking lot identifier, the password, an address (location), the total number of parking spaces, and the number of available parking spaces and the like. In addition, the parking lot entry stores information on the parking product provided by the corresponding parking lot. For example, the parking lot entry can store a parking product name such as a daily ticket, a weekly ticket, a monthly ticket, etc. provided by the corresponding parking lot, the parking product identifier (this identifier may be the parking product name) for distinguishing each parking product name, a parking product price and the like, and provide them to a certain user.

The parking lot entry further includes a user's use list. The user's use list stores contents related to his/her use of the present parking lot, and each entry of the user's use list stores the user identifier, the entry time, an exit time, a settled parking fee and the like. The user's use list further stores a user identifier for a user who has purchased the parking product provided by the present parking lot, a purchased parking product name and/or the parking product identifier.

The parking lot entry also includes a partnership store list and partnership store guide information. The partnership store list is a list that manages partnership stores where users who use the corresponding parking lot can receive parking benefits. An entry of the partnership store list includes a partnership store identifier and parking discount details (e.g., one hour discount, 20% discount) at the corresponding partnership store and the like. The partnership store identifier may be a name of the partnership store or a combination of the name and location. The partnership store identifier may be the mobile stamp identifier or includes the mobile stamp identifier.

The partnership store guide information may be, for example, an advertisement for the partnership store, and is configured with a video file, an image file, or an audio file. One certain partnership store guide information can be forwarded to the mobile phone in real time when entering the parking lot and can be displayed as an image.

The database stored in the storage unit 103 can be accessed and modified by the control unit 150.

The connection unit 170 transmits and receives data between the storage unit 130, the communication unit 110, and the control unit 150. The connection unit 107 may be configured with a parallel bus or a serial bus, or may be configured with a local network. The configuration of the connection unit 107 may vary depending on the hardware configuration example of the parking lot management server 100.

The control unit 150 controls the blocks of the parking lot management server 100. The control unit 150 receives various requests and data through the communication unit 110, processes the corresponding request or data by using the database, and forwards the processing result to the communication unit 110 to transmit the processing result to the device that has sent the request or data.

Several processing flows in the communication unit 110 will be briefly described. The communication unit 110 receives vehicle entry information including the vehicle license plate number from the local parking management terminal 300 through the network and forwards the received vehicle entry information to the control unit 150. The control unit 150 generates a vehicle entry guide message guiding the vehicle associated with the vehicle license plate number of the vehicle entry information to enter a specific parking lot. The control unit 150 identifies the user and the mobile phone that are associated with the vehicle license plate number in the database (user DB) by using the vehicle license plate number or the like, and transmits the generated vehicle entry guide message to the identified mobile phone (for example, identified by using the mobile phone identifier). For transmission of the vehicle entry guide message to the mobile phone, the control unit 150 forwards the vehicle entry guide message to the communication unit 110 and the communication unit 110 transmits the message to the corresponding mobile phone by using the mobile phone identifier. The vehicle entry guide message may be a push message serviced over the Internet. Accordingly, the vehicle entry guide message may be forwarded to the corresponding mobile phone through a push server.

The vehicle entry guide message includes, for example, information on the parking lot where the vehicle associated with the vehicle license plate number enters, and guide information of a partnership store associated with the parking lot, and the corresponding information is displayed on the mobile phone that has received the information.

After completion of vehicle entry, the control unit 150 can receive a mobile stamp identifier from a certain mobile phone through the communication unit 110. The control unit 150 can extract the user entry from the user DB using the identifier of the mobile phone and store the mobile stamp identifier in the extracted user entry (mobile stamp list). The stored mobile stamp identifier can be used for parking fee settlement afterward.

The control unit 150 can receive vehicle exit information for vehicle exit from the parking lot from the local parking management terminal 300. The vehicle exit information includes the vehicle license plate number, and settlement information used to settle the parking fee. The control unit 150 settles the parking fee of the vehicle associated with the vehicle license plate number by using the settlement information. The control unit 150 generates blocking bar control information according to the settlement of the parking fee, and forwards the blocking bar control information to the communication unit 110 to transmit the blocking bar control information to the local parking management terminal 300.

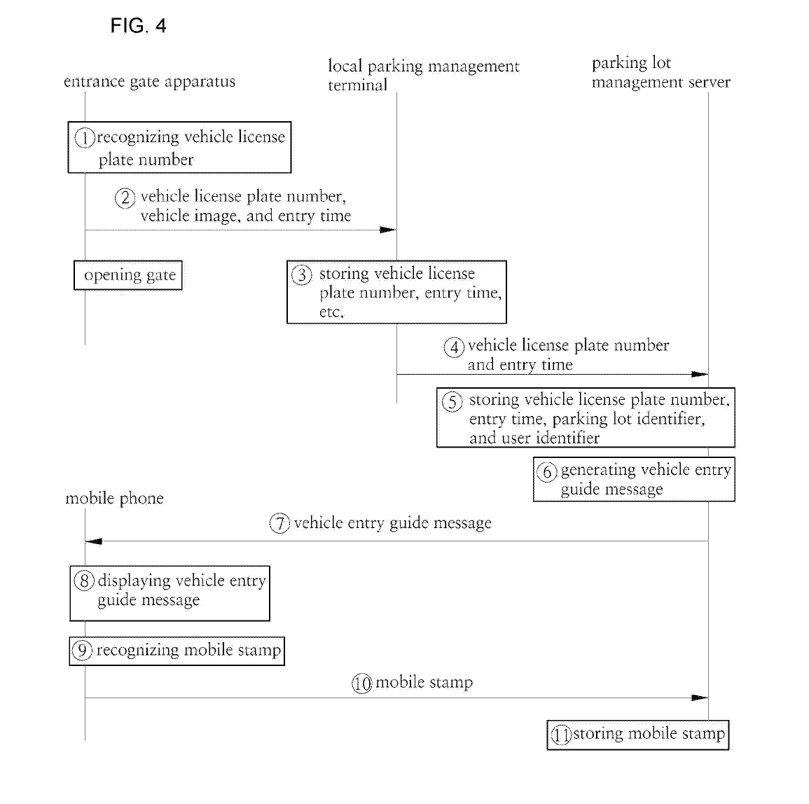

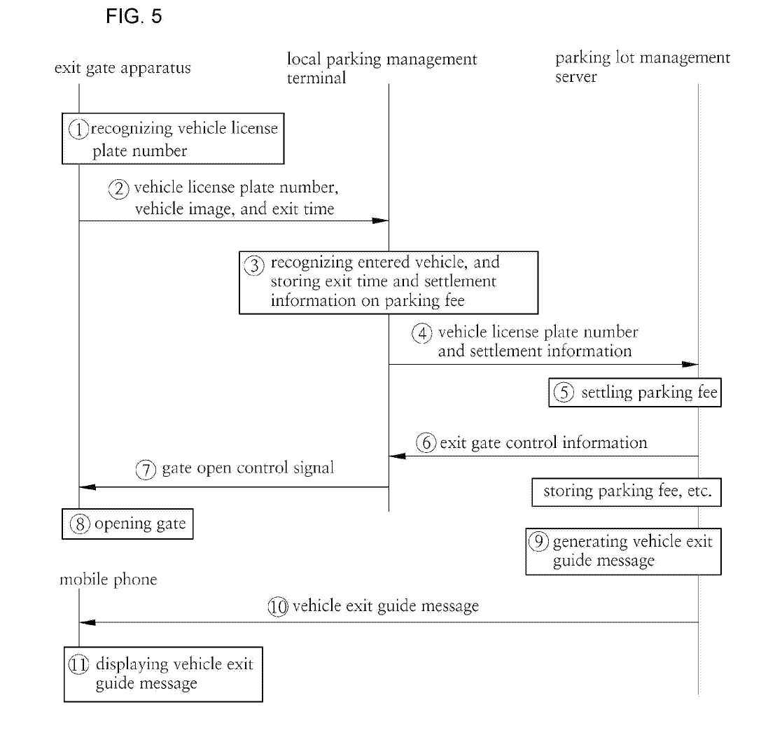

As described above, the control unit 150 receives and processes various data through the communication unit 110, and transmits the processing result. The processing flow in the control unit 105 will be described in more detail with reference to FIGS. 4 to 5.

FIG. 3 is a view showing an exemplary member registration and pre-purchasable parking product purchase flow for use of the parking lot management system. The flow of FIG. 3 is mainly performed between the user equipment 200 and the parking lot management server 100, and it is not necessary to be limited to a mobile phone because member registration or pre-purchase of the parking product is possible through a personal PC as well as the mobile phone.

The flow of FIG. 3 begins with a connection by the user equipment 200 and the control unit 150 of the parking lot management server 100 proceeds to receive and process data and information and to transmit response data via the communication unit 110.

First, the user equipment 200 can access the parking lot management server 100 through web browsing. The parking lot management server 100 provides the user equipment 200 with a guide web page for member registration and a member registration web page. Member registration proceeds by transmission and reception of various information between the user equipment 200 and the parking lot management server 100 according to the member registration web page (see \textcircled{1}).

In the member registration process, the parking lot management server 100 newly generates the user entry in the user DB and records various information obtained from the member registration process in the fields of the user entry. For example, the parking lot management server 100 records the name received from the user equipment 200, the identifier (ID), the password, the e-mail address, etc., and the mobile phone identifier in the generated user entry. Through the user entry, the parking lot management server 100 can forward a specific message or the like to the mobile phone.

In addition to the basic member registration, the user equipment 200 and the parking lot management server 100 set the environment necessary for using the parking lot management system (see \textcircled{2}). For example, the parking lot management server 100 receives the vehicle license plate number of the vehicle that will use the parking lot, the vehicle model name, etc. from the user, and records the vehicle license plate number, the vehicle model name, etc. in the user entry.

Further, the parking lot management server 100 sets various payment means to be used in the parking fee settlement (payment) by interworking with the user equipment 200. For example, the parking lot management server 100 can receive various credit card information to be used for the parking fee settlement from the user equipment 200, and record the received credit card information in the credit card list of the user entry. The credit card information includes, for example, the credit card name, the card number, the expiration date, the credit card company name, the credit card type, the password, and the like.

Meanwhile, the parking lot management server 100 generates cyber money at the time of member registration. The cyber money can be charged during or after the environment setting. For example, according to a charging request from the user, points of a registered certain credit card can be charged by the cyber money, or the cyber money can be charged in accordance with credit card payment using the certain credit card. The cyber money can be used to settle the parking fee at the time of deferred payment of the parking fee in preference to other registered credit cards.

According to the environment setting for system use, the parking lot management server 100 registers a credit card to enable credit card payment (see \textcircled{3}). Various data of the credit card confirmed through the registration of credit card are preferably recorded as credit card information in the credit card list of the corresponding user.

For the registration of credit card, the parking lot management server 100 performs data communication with the PG server 600 through the network. For example, the parking lot management server 100 transmits a credit card use approval request including the credit card company name, the card number, the expiration date, and the password, and the like to the PG server 600. The PG server 600 forwards various information of the received use approval request to a system (server) of the credit card company and receives an approval result from the credit card company. The PG server 600 transmits the received approval result and an approval identifier (for example, a billing number) according to the approval to the parking lot management server 100. When the credit card is approved, the parking lot management server 100 records the approval identifier together with various card information or together with some card information as the credit card information of the credit card list, thereby completing the registration of credit card.

The parking lot management server 100 can perform registration for all credit cards provided by the user. The credit cards can be used for deferred payment of the parking fee, and have priorities in payment of the parking fee, so that a certain credit card can be used for payment with priority according to its priority. In the deferred payment, the cyber money can be set as the top priority and can be used with priority as the payment means.

The user can pre-purchase parking products provided by a certain parking lot to use the corresponding parking lot. The user equipment 200 searches for available parking products (see \textcircled{4}) by interworking with the parking lot management server 100. The parking lot management server 100 receives a search request having a search condition from the user equipment 200, searches the parking lot DB of the storage unit 130 according to the search condition, and outputs a search result to the user equipment 200. The search condition may indicate a search within a specific location radius based on the location. For the location-based searching, the user equipment 200 can transmit a location determined through the GPS module to the parking lot management server 100.

The search result is retrieved by the search condition and displayed on the user equipment 200. The search result can be displayed in an icon form on a map displayed on the user equipment 200. The search result includes various information extracted from the entry of the parking lot DB. For example, the search result includes the parking lot name, the parking lot location, the parking product name (the daily ticket, the weekly ticket, etc.), the parking product price, and the like of each parking lot matching the search condition.

Upon receipt of the search result, the user equipment 200 displays the search result in the icon form on the map by using location data of the received search result, and displays through a pop-up window the data (parking product name, parking product price, etc.) of the icon selected by input (for example, user touch, mouse movement, etc.) received from the user. The user equipment 200 includes an application program for using the present system and can communicate with the parking lot management server 100 using the application program. The application program is, for example, an App program available on a mobile phone, particularly a smartphone or a tablet PC.

The user selects a certain parking product in a certain parking lot by confirming the displayed icon or data and transmits a payment request (see \textcircled{5}). The parking lot management server 100 interworking with the App program identifies the certain parking product of the certain parking lot using input from the connected user equipment 200 and identifies the payment means using the input from the user equipment 200. For example, the parking lot management server 100 can provide the registered credit card list to the user equipment 200 and identify the payment means by selecting a certain credit card. In this process, the user can pay using credit card points of the certain credit card, or using cyber money.

The credit card payment is made using the credit card list, and a payment result can be stored (see \textcircled{6}). Specifically, according to the payment request, the parking lot management server 100 extracts the approval identifier from the selected credit card information of the credit card list of the user identified through login or the like. The parking lot management server 100 transmits a credit card payment request including the approval identifier and the parking product price to the PG server 600. The credit card payment request may further include other information required for the credit card payment, and may further include, for example, the expiration date, the password, etc. The PG server 600 attempts to make payment through the system of the credit card company and transmits the payment result to the parking lot management server 100.

The parking lot management server 100 that has received the payment result receives subsequent processing according to the payment result. When payment is successfully made, the parking lot management server 100 updates the user's use list of the entry of the certain parking lot (identified by the parking lot identifier) of the parking lot DB. For example, the user identifier, the parking product name, and the parking product identifier are stored in the entry of the user's use list. The parking lot management server 100 further updates a parking product list of a user entry of the user DB. For example, the parking lot identifier, the parking product identifier, the purchase price, duration, and the like are stored in one product information of a parking product list of a certain user.

When payment is not successfully made, a message or the like indicating this can be generated and transmitted to the user equipment 200.

After storing various information according to the pre-purchasing, the parking lot management server 100 transmits a parking product registration request to the local parking management terminal 300 (which can be identified using the parking lot identifier, etc.) of the parking lot of which a parking product is pre-purchased (see \textcircled{7}). The parking product registration request includes the parking product name, the parking product identifier, the user identifier, and the vehicle license plate number. The registration request may further include information on available duration of the parking product.

The local parking management terminal 300 that has received the registration request stores the parking product name and/or identifier, the user identifier, and the vehicle license plate number of the registration request in the storage medium provided in the local parking management terminal 300 (see \textcircled{8}), and transmits a response to the request to the parking lot management server 100 (see \textcircled{9}). The response may indicate registration completion or registration failure.

The parking lot management server 100 that has received the response according to the registration request can transmit a message indicating payment completion to the user equipment 200 by confirming the response indicating registration completion (see \textcircled{10}), and terminate the pre-purchasing process of the parking product.

FIG. 3 is a view showing the processes of member registration and parking product purchase in a single drawing. Generally, the member registration and parking product purchase processes can proceed independently. In the case that said processes proceed independently, the user can first access the parking lot management server 100 through a login process, and then perform a process of \textcircled{4} and below.

FIG. 4 is a view showing an exemplary flow in the present parking lot management system for processing parking lot vehicle entry and a parking discount. The flow of FIG. 4 is accomplished through cooperation between various devices. Here, the contents described with reference to FIGS. 1 to 3 will be briefly described.

First, the entrance gate apparatus 400 installed at the entrance gate of a certain parking lot recognizes an approaching vehicle (for example, using an ultraviolet sensor or the like), and recognizes a vehicle license plate number according to the recognition of the vehicle (see \textcircled{1}).

Specifically, the control module of the entrance gate apparatus 400 executes the camera module to capture a vehicle image and extract the vehicle license plate number from the captured vehicle image. The vehicle license plate number can be extracted using the OCR program.

In consideration of the case where the vehicle license plate number cannot be automatically recognized, it would be even more desirable if the entrance gate apparatus 400 could provide an additional way to extract the vehicle license plate number. For this purpose, the entrance gate apparatus 400 is provided with the beacon module, the NFC module, and/or the RF module, so that the vehicle license plate number can be supplementarily extracted.

For example, the beacon module periodically transmits a Bluetooth radio signal and can receive a Bluetooth radio signal from a mobile phone of a user who registered in the present system. The received Bluetooth signal allows the user of the mobile phone to be identified. Upon reception of the Bluetooth signal, the entrance gate apparatus 400 recognizes a user identifier of an adjacent mobile phone. For example, the entrance gate apparatus 400 further includes a storage medium and stores various information on users who can use the present system in advance. For the recognition of the identifier, the entrance gate apparatus 400 extracts an identifier of a predetermined format from the received Bluetooth signal. The extracted identifier may be a user identifier or a mobile phone identifier. The entrance gate apparatus 400 searches for the stored user information using the extracted identifier, and determines the vehicle license plate number associated with the searched identifier.

Alternatively, the NFC module or the RF module performing near field communication recognizes the identifier of the mobile phone by interworking with an NFC interface of the mobile phone, and determines the vehicle license plate number of the user's vehicle using the user information of the storage medium. Further, when the vehicle license plate number is not recognized, the vehicle license plate number may be determined by identifying a location of the mobile phone.

When the vehicle license plate number is not recognized, the process of determining the vehicle license plate number can be auxiliarly performed by the entrance gate apparatus 400 having the storage medium. However, depending on the design modification, the vehicle license plate number may be determined by the local parking management terminal 300. For example, the entrance gate apparatus 400, which does not have the storage medium or does not store the user information, transmits the identifier recognized from the NFC module or the like to the local parking management terminal 300 and the local parking management terminal 300 can determine the vehicle license plate number of the vehicle entering.

The entrance gate apparatus 400 transmits data including the recognized vehicle license plate number, the captured vehicle image, and the entry time to the local parking management terminal 300 through the local network (see \textcircled{2}). Meanwhile, the entrance gate apparatus 400 controls the blocking bar to open the entrance gate after recognizing the vehicle license plate number.

Upon receipt of the data, the local parking management terminal 300 stores the received data in the storage medium. For example, the local parking management terminal 300 stores the vehicle license plate number, the vehicle image, and the entry time in the storage medium (see \textcircled{3}). In addition, the local parking management terminal 300 can extract a user identifier from information that is stored in the storage medium according to the pre-purchasing of the parking product. When the received vehicle license plate number is retrieved from the storage medium and a user identifier associated therewith can be extracted, it can be known that the vehicle associated with the vehicle license plate number is a vehicle of a user who pre-purchased the parking product.

After receiving the vehicle license plate number, etc. from the entrance gate apparatus 400, the local parking management terminal 300 transmits vehicle entry information on the corresponding parking lot to the parking lot management server 100 (see \textcircled{4}). The vehicle entry information includes the vehicle license plate number and the entry time, and further includes the user identifier in the case of the vehicle of the user who pre-purchased the parking product.

The parking lot management server 100 receives the vehicle entry information (see \textcircled{4}), stores the vehicle license plate number, the entry time, the user identifier, the parking lot identifier and the like in the storage unit 130 (see \textcircled{5}).

Specifically, the parking lot management server 100 determines the parking lot identifier by a network connection (for example, a session connection) with the local parking management terminal 300 or by the login of the local parking management terminal 300. In addition, the parking lot management server 100 searches the user DB based on the vehicle license plate number as the search condition to determine the user identifier. The user identifier may of course be extracted from the vehicle entry information. The determination of the user identifier may be omitted depending on the modified example.

According to the determination of the identifiers, the parking lot management server 100 stores the vehicle entry information in the user DB, the parking lot DB and the like. Specifically, assuming that the user DB and the parking lot DB exist separately in the parking lot management server 100, the parking lot management server 100 extracts a user entry using the user identifier and generates and stores new vehicle entry and exit information in parking lot vehicle entry and exit lists of the extracted user entry. The vehicle entry and exit information includes, for example, the vehicle license plate number and the parking lot identifier. In addition, the parking lot management server 100 extracts a parking lot entry from the parking lot DB using the parking lot identifier, and generates and stores new parking lot user information in a user's use list of the parking lot entry. The parking lot user information includes, for example, the user identifier and the entry time.

In the case that the user identifier cannot be extracted, the storage of the user identifier and the entry generation using the user DB may be omitted.

Thereafter, the parking lot management server 100 generates the vehicle entry guide message for the vehicle associated with the vehicle license plate number (see \textcircled{6}). The vehicle entry guide message can be generated using the parking lot DB.

The generation of the vehicle entry guide message is described in detail. The parking lot management server 100 extracts the parking lot entry from the parking lot DB using the parking lot identifier, and configures parking (vehicle entry) information such as the parking lot name, the parking lot location, and/or the entry time in the extracted parking lot entry. In addition, the parking lot management server 100 extracts a partnership store list and/or partnership store guide information from the parking lot entry, and configures guide information of the partnership store associated with or connected to the corresponding parking lot based on the extracted information. The guide information may include at least one selected from the group consisting of at least one partnership store name selected in the partnership store list, a partnership store location, a guide map (image) that provides directions from the parking lot where the vehicle has entered to the partnership store, etc. Alternatively, the guide information may include a file for advertising a certain partnership store. The file need not necessarily be included in the guide information. However, it may be configured to be connectable through a link (for example, a URL). Alternatively, the guide information may include information and files associated with the partnership store.

The parking lot management server 100 extracts a mobile phone identifier from the user DB using the user identifier. This mobile phone identifier enables the mobile phone associated with the received vehicle license plate number to be identified. The parking lot management server 100 transmits the generated vehicle entry guide message to the mobile phone identified using the mobile phone identifier (see \textcircled{7}). The transmitted vehicle entry guide message may be forwarded to the push server. The push server can forward the received vehicle entry guide message to the corresponding mobile phone. Thus, the parking lot management server 100 can determine the user identifier using the received vehicle license plate number and transmit the vehicle entry guide message to the mobile phone associated with the user identifier.

According to the transmission of the vehicle entry guide message, the mobile phone (user equipment 200) receives the vehicle entry guide message through the Internet or mobile communication network (see \textcircled{7}). The mobile phone displays the received vehicle entry guide message through the display module (see \textcircled{8}). Thus, the user can automatically recognize that the user has entered a certain parking lot without any other confirmation or parking ticket confirmation. The vehicle entry guide message includes the parking lot name, the entry time, etc., and further includes information or an advertisement related to the partnership store.

Through such a series of processes, vehicle entry into the parking lot is completed.

Meanwhile, the user can use various stores near the parking lot where the vehicle entered. The user can confirm the partnership store through the vehicle entry guide message and patronize the corresponding partnership store.

The parking lot management system according to the present invention is configured such that when the user patronizes a certain store, the user can automatically receive the parking discount provided by the corresponding store. The parking discount is typically available in two ways.

One method is to use a PC installed in the store. A store manager can access the parking lot management server 100 through the PC and apply the parking discount for the corresponding vehicle by searching for the vehicle license plate number. For example, the store manager searches for the vehicle license plate number and applies a parking discount coupon to the corresponding vehicle license plate number (e.g., a one hour free coupon, a 30% parking fee discount coupon). Accordingly, the corresponding parking discount details are recorded in an entry that is retrieved from the user DB or the parking lot DB using the vehicle license plate number. This method can be performed through the web.

Another method is to use a mobile stamp provided in the store. According to the request of the user, the store manager provides the mobile stamp to the user. The mobile stamp has at least an identifier for distinguishing it from other mobile stamps, and an image of the mobile stamp is temporarily stored in the mobile phone by image recognition (see \textcircled{9}) through the camera module of the mobile phone. The mobile phone's App program extracts a mobile stamp identifier from the captured image. The mobile stamp is preformatted according to a predetermined format, and each store has a different identifier. The mobile stamp identifier enables the partnership store to be identified. The mobile stamp identifier can be extracted from the captured image and the captured image itself may be the identifier.

The mobile phone transmits the recognized mobile stamp information to the parking lot management server 100 (see \textcircled{10}), and the parking lot management server 100 stores the received mobile stamp information (see \textcircled{11}).

The user can store mobile stamps of various partnership stores. The mobile stamp information includes at least the mobile stamp identifier. The mobile stamp information may further include various other information. For example, the mobile stamp information may further include time of use, applicable discount details, the name or identifier of the partnership store, and the like. The mobile stamp identifier is configured to identify at least a certain mobile stamp, further identify a certain partnership store, and further identify applicable discount details, etc. The user identifier is determined by connection with the mobile phone, a new mobile stamp (information) is generated in a mobile stamp list of the extracted user entry, and each information of the mobile stamp information is stored in the parking lot management server 100.

Through the above process, the user can automatically apply the parking discount details on-line without obtaining a separate parking discount ticket.

FIG. 5 is a view showing an exemplary flow in the parking lot management system when a vehicle exits the parking lot. The flow of FIG. 5 is accomplished through cooperation between various devices. Here, the contents described with reference to FIGS. 1 to 4 will be briefly described.

The exit gate apparatus 500 recognizes the entering vehicle and recognizes the vehicle license plate number according to the recognition of the vehicle (see \textcircled{1}). Specifically, the control module of the exit gate apparatus 500 captures the vehicle image according to execution of the camera module and extracts the vehicle license plate number using the OCR program.

When automatic extraction from the vehicle image is impossible, auxiliary means can be used. For example, the exit gate apparatus 500 is provided with the beacon module, the NFC module, and/or the RF module so that the vehicle license plate number can be supplementarily extracted through wireless communication.

The determination of the vehicle license plate number using the auxiliary module can be performed by the exit gate apparatus 500 or by the local parking management terminal 300.

The exit gate apparatus 500 transmits data including the vehicle license plate number, the vehicle image, and the exit time to the local parking management terminal 300 through the local network before raising the blocking bar (see \textcircled{2}).

Upon receipt of the vehicle exit data, the local parking management terminal 300 identifies an entered vehicle by searching for data (vehicle entry data) stored at the time of entry of the vehicle using the vehicle license plate number, and settles the parking fee based on the parking time calculated using a difference between the entry time and the exit time. Settlement information on the settled parking fee, the exit time, and the vehicle image at the time of exit of the vehicle are stored in the storage medium together with the vehicle license plate number, the entry time, etc. of vehicle entry data (see \textcircled{3}). The settlement information may include, for example, data such as the entry time, the exit time, the parking time calculated using the difference between the entry time and the exit time, a parking rate per hour (per minute), the parking fee calculated using the parking time and the parking rate, and the like.

Further, the local parking management terminal 300 can perform extraction of the user identifier of the user who is associated with the vehicle license plate number and who has pre-purchased the parking product.

The local parking management terminal 300 transmits vehicle exit information including at least the vehicle license plate number and the settlement information to the parking lot management server 100 (see \textcircled{4}), and the parking lot management server 100 receives the vehicle exit information (see \textcircled{4}). The vehicle exit information may further include the user identifier of the user who has pre-purchased the parking product and the identifier of the pre-purchased parking product.

The parking lot management server 100 that has received the vehicle exit information settles the parking fee of the user associated with the vehicle license plate number using the settlement information of the vehicle exit information (see \textcircled{5}).

The process of settling the parking fee is described in detail. The parking lot management server 100 identifies the user associated with the vehicle license plate number of the vehicle exit information. The identification of the user is performed by determining the user identifier, for example, by extracting the user identifier included in the vehicle exit information or by extracting the user identifier of the user entry retrieved by retrieving the vehicle license plate number from the user DB.

After identifying the user, parking lot management server 100 determines whether the identified user is an identifier of a member who has pre-purchased a parking ticket. The determination of the member who pre-purchased the parking ticket is performed using, for example, the user identifier or the parking product identifier included in vehicle exit information, or using the parking product list of the retrieved user entry. For example, when the identifier of the parking lot that transmitted the vehicle exit information is compared with the parking lot identifier of the parking product list, and the same parking lot identifier is determined, the parking lot management server 100 can determine whether the identified user is a member who has pre-purchased the parking product provided by the corresponding parking lot.

When the identified user is the member who has pre-purchased the parking product, the parking lot management server 100 settles the parking fee using the parking product identifier. For example, the parking lot management server 100 may determine that there is no fee to be settled and may not request an additional fee payment.

When the identified user is a member who has not pre-purchased the parking product, the parking lot management server 100 calculates an actual amount of the parking fee to be paid using the settlement information. The actual amount of the parking fee to be paid is discounted using the mobile stamp.

Specifically, the parking lot management server 100 extracts the parking fee from the settlement information and retrieves the mobile stamp list from the identified user entry. Each mobile stamp identifier of the mobile stamp list is compared with the identifier of the entry of the partnership store list corresponding to the parking lot that charges the parking fee, and it is determined whether a matching identifier exits. When the matching identifier exits, the parking discount details corresponding to the mobile stamp identifier or the identifier of the partnership store list are applied to the received parking fee. Thus, the parking lot management server 100 enables automatic parking discount and can associated with various stores. The discount using the mobile stamp can be duplicated through various partnership stores.

Of course, through the connection of the parking lot management server 100 using a PC, the parking lot management server 100 may apply the parking discount through the web.

To settle the parking fee, the parking lot management server 100 calculates (discounts) the parking fee by applying the actual discount details and then determines whether the amount of the pre-charged cyber money is greater than that of the parking fee to be settled. When the amount of the cyber money is greater than that of the parking fee be settled, the cyber money is deducted by the parking fee and the settlement is completed. The deducted cyber money is stored in the user entry.

When the amount of the cyber money is less than that of the parking fee or the cyber money does not exist, the parking lot management server 100 determines whether the user is a member whose credit card is registered (approved). Whether the user is the member whose credit card is approved can be determined by whether the approval identifier exists in the credit card list of the user entry. When the user is the member whose credit card is approved, the parking lot management server 100 requests payments to the PG server 600 by using the approval identifier, the deducted parking fee, and other credit card information, and receives a normal approval result.

When the user is a member whose credit card is not approved, the parking lot management server responds to the vehicle exit information and transmits data indicating that the parking fee payment is impossible to the local parking management terminal 300. The local parking management terminal 300 outputs a signal indicating that the user is the member whose credit card is not approved or automatic payment is impossible to the exit gate apparatus 500, and the exit gate apparatus 500 outputs the corresponding signal. Thus, the vehicle user can settle the parking fee through an automated payment machine or the like.

The user inputs the vehicle license plate number through the automated payment machine, and the automated payment machine displays the calculated parking fee corresponding to the vehicle license plate number and the parking fee can be paid using a credit card or cash. The parking fee is received from the local parking management terminal 300 or from the parking lot management server 100.

According to the settlement of the parking fee, the parking lot management server 100 stores data including the received vehicle exit information, the settled parking fee and the like in the storage unit 130, and generates and transmits exit gate control information to the local parking management terminal 300 (see \textcircled{6}). The exit gate control information is generated in accordance with the settlement of the parking fee, and may be, for example, a control command that causes the exit gate to open.

The local parking management terminal 300 generates and forwards a gate open control signal (data) transmitted through the local network upon receipt of the exit gate control information (see \textcircled{7}).

The exit gate apparatus 500 that has received the gate open control signal raises the blocking bar to open the exit gate (see \textcircled{8}). According to the completion of the opening, the local parking management terminal 300 can transmit a response to the exit gate control information indicating that the exit gate has been opened to the parking lot management server 100.

After transmitting the exit gate control information, preferably after receiving the response, the parking lot management server 100 generates a vehicle exit guide message. The vehicle exit guide message is a message indicating that vehicle exit from the parking lot is completed, and includes, for example, information on the parking lot, parking information on vehicle entry and exit, and settlement information according to the parking fee settlement. The information on the parking lot includes data such as the name and location of the parking lot where the user's vehicle parked, etc., the parking information includes data such as the entry time, the exit time, the parking time, etc., and the settlement information includes data such as an original parking fee, a discounted parking fee, discount details, etc.

The vehicle exit guide message is forwarded to the identified user's mobile phone and may be forwarded via the push server.

Through the vehicle entry and exit processes of FIGS. 4 and 5, it is possible for the vehicle user to settle and discount the parking fee automatically, and it is possible for the parking lot to be managed remotely without requiring the presence of a parking lot manager. Meanwhile, by using the App program on a mobile phone, the user can visit the parking lot from his/her location, and search for and reserve entry to the parking lot registered in the present system on the map.

Although embodiments of the present invention were described in detail above, the scope of the present invention is not limited to the embodiments and various changes and modifications from the spirit of the present invention defined in the following claims by those skilled in the art are also included in the scope of the present invention.

1. A parking lot management method, comprising the steps of:
receiving a vehicle license plate number from an entrance gate apparatus connected to a local parking management terminal, and attempting to extract from information stored in the local parking management terminal a user identifier of a user who is associated with the vehicle license plate number received and who has pre-purchased a parking product;
transmitting by the local parking management terminal vehicle entry information including the vehicle license plate number to a parking lot management server, wherein when the user identifier is extracted, the vehicle entry information further includes the user identifier;
(a) receiving by the parking lot management server the vehicle entry information including the vehicle license plate number from the local parking management terminal;
determining by the parking lot management server a parking lot identifier of the local parking management terminal that has transmitted the vehicle entry information and the user identifier associated with the vehicle license plate number of the vehicle entry information, wherein the determined user identifier is included in the vehicle entry information or is the user identifier associated with the vehicle license plate number in the parking lot management server;
(b) generating by the parking lot management server a vehicle entry guide message of a vehicle associated with the vehicle license plate number; and
(c) determining by the parking lot management server a mobile phone identifier from database provided in the parking lot management server by using the determined user identifier, and transmitting the vehicle entry guide message to a user's mobile phone associated with the vehicle license plate number by using the mobile phone identifier,
wherein the vehicle entry guide message includes information on a parking lot where the vehicle associated with the vehicle license plate number enters, and guide information on a partnership store associated with the parking lot, the vehicle entry guide message being displayed on the user's mobile phone.

2. The parking lot management method of claim 1, further comprising the steps of:
(e) receiving by the parking lot management server vehicle exit information including the vehicle license plate number and settlement information from the local parking management terminal;
(f) settling by the parking lot management server a parking fee of the vehicle associated with the vehicle license plate number by using the settlement information; and
(g) transmitting by the parking lot management server exit gate control information to the local parking management terminal, the exit gate control information generated according to the settlement of the parking fee and used to control an exit gate apparatus connected the local parking management terminal.

3. The parking lot management method of claim 1, further comprising the steps of:
after the step (c), recognizing by the user's mobile phone an image of a mobile stamp through a camera module provided in the user's mobile phone;
extracting a mobile stamp identifier from the recognized image;
(d) receiving by the parking lot management server from the user's mobile phone the mobile stamp identifier recognized by the user's mobile phone; and
mapping the mobile stamp identifier to the user identifier associated with the user's mobile phone and storing the mobile stamp identifier,
wherein the mobile stamp identifier is used for parking fee settlement.

4. The parking lot management method of claim 2, further comprising the steps of:
opening by the local parking management terminal an exit gate according to the exit gate control information; and
transmitting by the parking lot management server a vehicle exit guide message to the user's mobile phone associated with the vehicle license plate number after the opening the exit gate,
wherein the vehicle exit guide message includes information on the parking lot where the vehicle exits, parking information on vehicle entry and exit, and settlement information on the parking fee.

5. The parking lot management method of claim 2, wherein the step (f) includes:
determining by the parking lot management server the user identifier of the user associated with the vehicle license plate number;
determining whether the determined identifier is an identifier of a member who has pre-purchased the parking product; and
when the user is a member who has not pre-purchased the parking product, settling the parking fee for the user identifier by using approval identifier of a pre-approved credit card.

6. A parking lot management server, comprising:
a communication unit receiving vehicle entry information including a vehicle license plate number and transmitting a vehicle entry guide message to a user's mobile phone associated with the vehicle license plate number; and
a control unit determining a parking lot identifier associated with a local parking management terminal that has transmitted the vehicle entry information and a user identifier of a user associated with the vehicle license plate number of the vehicle entry information, generating a vehicle entry guide message for a vehicle associated with the vehicle license plate number, and determining a mobile phone identifier from a database provided in the parking lot management server by using the user identifier, the control unit forwarding the vehicle entry guide message to the communication unit to transmit the generated vehicle entry guide message to the user's mobile phone associated with the vehicle license plate number by using the mobile phone identifier,
wherein the vehicle entry information is generated by the local parking management terminal, and further includes, when the user associated with the vehicle license plate number is a user who has pre-purchased a parking product of the local parking management terminal, the user identifier extracted from information stored in the local parking management terminal,
the determined user identifier is included in the vehicle entry information or is the user identifier associated with the vehicle license plate number in the parking lot management server, and
the vehicle entry guide message includes information on a parking lot where the vehicle associated with the vehicle license plate number enters, and guide information on a partnership store associated with the parking lot, the vehicle entry guide message being displayed on the user's mobile phone.

7. The parking lot management server of claim 6, wherein the communication unit further receives vehicle exit information including the vehicle license plate number and settlement information, and
the control unit settles a parking fee of the vehicle associated with the vehicle license plate number by using the settlement information, generates exit gate control information used to control an exit gate apparatus connected to the local parking management terminal according to the settlement of the parking fee, and transmits the exit gate control information to the communication unit.

8. The parking lot management server of claim 7, wherein before receiving the vehicle exit information, the communication unit receives from the user's mobile phone a mobile stamp identifier recognized by the user's mobile phone, and
the control unit maps the received mobile stamp identifier to the user identifier associated with the user's mobile phone, stores the mobile stamp identifier, and discounts the parking fee settled using the settlement information by further using the stored mobile stamp identifier.

9. A parking lot management system, comprising:
the parking lot management server of claim 6.

10. The parking lot management system of claim 9, further comprising:
at least one local parking management terminal connected to the parking lot management server through a network; and
an entrance gate apparatus connected to the local parking management terminal,
wherein the entrance gate apparatus captures a vehicle image, extracts the vehicle license plate number from the captured vehicle image, and when the vehicle license plate number is not extracted, recognizes the user identifier of the vehicle entering the parking lot through wireless communication.

11. The parking lot management system of claim 10, further comprising:
an exit gate apparatus connected to the local parking management terminal,
wherein the local parking management terminal opens an exit gate by controlling the exit gate apparatus according to the received exit gate control information,
the parking lot management server transmits a vehicle exit guide message to the user's mobile phone after the exit gate control information is transmitted to the local parking management terminal, and
the vehicle exit guide message includes information on the parking lot where the vehicle exits, parking information on vehicle entry and exit, and settlement information on the parking fee.
